(19) United States
(12) Patent Application Publication
(10) Pub. No.: US 2025/0108846 A1
(43) Pub. Date: Apr. 3, 2025

(54) INSPECTION METHOD AND INSPECTION SYSTEM FOR VEHICLES

(71) Applicant: GESTALT Automation GmbH, Berlin (DE)

(72) Inventors: Thomas STAUFENBIEL, Berlin (DE); Eugen FUNK, Berlin (DE)

(21) Appl. No.: 18/899,618

(22) Filed: Sep. 27, 2024

(30) Foreign Application Priority Data
Sep. 29, 2023 (EP) 23200709.6

(51) Int. Cl. B61L 27/57; B61L 25/02; G06T 7/00; G06T 7/70; G06V 10/80

(52) U.S. Cl. CPC B61L 27/57; B61L 25/021; G06T 7/0004; G06T 7/70; G06V 10/80; G06T 2207/20221; G06T 2207/30252; G06V 2201/08

(57) ABSTRACT

The invention relates, inter alia, to an inspection method for inspecting a vehicle, the inspection method comprising: monitoring, preferably tracking, a current vehicle position of the vehicle along a route for the vehicle via a sensor system; determining at least one triggering time for a scanner device in dependence on the monitored current vehicle position; and triggering the scanner device at the determined at least one triggering time for scanning at least one desired inspection section of the vehicle.

### CROSS REFERENCE TO RELATED APPLICATIONS

This application claims the benefit under 35 U.S.C. § 119 (a) of European Patent Application No. EP 23200709.6, filed Sep. 29, 2023 entitled INSPECTION METHOD AND INSPECTION SYSTEM FOR VEHICLES, and whose entire disclosure is incorporated by reference herein.

### TECHNICAL FIELD

The invention relates to an inspection method and an inspection system for inspecting a vehicle, preferably a rail vehicle. The invention also relates to a computer program product.

### TECHNICAL BACKGROUND

It is often necessary to take visual recordings of vehicles, such as trains, in order to facilitate the inspection or maintenance of the vehicle, for example. In addition to manual inspection or manual image capturing by employees at the vehicle, methods from the areas of machine vision or artificial intelligence can also be used for this purpose. Methods known today use a fixed camera to generate image captures of sections of the passing vehicle at equidistant time intervals.

For the automated inspection of certain objects on the vehicle, it is necessary to capture them clearly with the camera. However, with equidistant time intervals, this is only possible with insufficient accuracy because the vehicle speed is not constant and thus the vehicle position relative to the start of the recording is rather random. This results in images, for example, that hit the targeted object rather randomly.

In addition, there are many other problematic cases to consider. If the vehicle stops during the inspection, image capturing will be generated from the same position of the vehicle, causing high and unnecessary processing and storage costs. If the train moves a little slower or a little faster than expected, the data becomes unusable for detecting defects or anomalies. This is because the overlaps or gaps between the photographed sections make automatic analysis difficult or impossible.

WO 2018/087340 A2 relates to an inspection system and an inspection method for the automated inspection of a technical functional state of inspection sections of a vehicle using a sensor system for recording actual raw data from inspection sections of the vehicle to be inspected. For example, a camera can be triggered by a light barrier. The sensor system comprises at least one camera system for recording surface images. The camera system can comprise both continuous and triggered recording cameras.

The invention is based on the problem of creating an improved technique for inspecting vehicles, preferably trains, which makes it possible to capture a desired inspection section of a vehicle passing a scanner device with a high degree of accuracy, preferably with a comparatively low processing and storage effort.

### SUMMARY OF THE INVENTION

The problem is solved by the features of the independent claims. Advantageous further developments are indicated in the dependent claims and the description.

One aspect of the present disclosure concerns an inspection method (e.g., fully or partially automated) for inspecting a vehicle, preferably a rail vehicle (e.g., a train, such as a self-propelled train). The inspection method comprises monitoring, preferably tracking, a current vehicle position of the vehicle along a (e.g., predetermined) route (e.g., rail or road) for the vehicle by means of a sensor system. The inspection method further comprises determining at least one (future) triggering time of a, preferably camera-based, scanner device (e.g., a roof scanner device, underfloor scanner device or longitudinal side scanner device) depending on the monitored current vehicle position. The inspection method further comprises triggering the scanner device at the determined at least one triggering time for scanning at least one desired inspection section of the vehicle.

The approach described above can result in enormous differences and advantages over conventional methods. The image data or scanner data can map/scan the targeted objects in the same format. This enables automatic analysis using image processing software. No extremely complex AI software is required for the evaluation, since the received images comprise hardly any or no shifts in relation to one another, but instead show substantially the same image sections. This is the only way to create the conditions for automatic inspection using image processing algorithms that are applied to the images taken by the scanner device. This can also be beneficial for promoting adaptive, flexible and automatic vehicle inspection systems. Excess storage (IT infrastructure, costs) of unnecessary images when a vehicle is stationary can be prevented. It also prevents unnecessary processing (energy, costs) of unnecessary images in the event of a vehicle standstill. Nor is it necessary to take an unnecessarily large number of memory-intensive and processing-intensive scanner images with the aim of hitting the desired inspection section as well as possible. Instead, the very precise determination of the triggering time makes it possible to scan only the actually desired inspection section.

It is possible that only a single triggering time is determined for the scanner device and the scanner device is triggered at the determined single triggering time to scan at least one desired inspection section.

It is also possible that a plurality of triggering times are determined for the scanner device and the scanner device is triggered at the respective determined triggering times for scanning a plurality of desired inspection sections.

It is also possible that a plurality of scanner devices are comprised and at least one triggering time is determined for each scanner device and the respective scanner device is triggered at the respective at least one triggering time.

Preferably, the monitoring, the determining and/or the triggering can be performed automatically by means of a processing device.

In one embodiment, the sensor system comprises a plurality of sensor devices, preferably comprising at least one binary position sensor (e.g., a light barrier) and/or at least one speed detection device (e.g., a lidar device, a radar device and/or a camera device). The multiple sensor devices can advantageously enable redundant measurements, for example, to enable a high degree of accuracy in monitoring the current vehicle position even in difficult (e.g., weather) conditions.

In a further embodiment, the monitoring of the current vehicle position comprises a sensor fusion (sensor data fusion) of signals from the sensor system's plurality of sensor devices. Advantageously, this can enable a particularly high level of accuracy when monitoring the current vehicle position.

In one embodiment, the sensor system comprises at least one binary position sensor, preferably a light barrier. Optionally, a signal from the at least one binary position sensor can indicate that a predetermined part of the vehicle is passing (has passed) the respective binary position sensor. Preferably, the predetermined part can be a wheel or a vehicle undercarriage or a bogie of the vehicle. It is advantageous that the vehicle position can be detected very precisely at a specific point on the route by means of the binary position sensor.

In a further embodiment, the monitoring of the current vehicle position also comprises detecting a current vehicle position along the route by means of a plurality of binary position sensors, preferably light barriers, of the sensor system. Optionally, the plurality of binary position sensors can be arranged at a distance from one another along the route and/or on both sides of the route. The advantage of this is that the binary position sensors can be used to detect the vehicle's position very precisely at several specific points along the route. The current vehicle position can be estimated, for example, between these highly precisely detected vehicle positions. Binary position sensors arranged on both sides enable redundant measurements.

In one embodiment, the inspection method also comprises monitoring the current driving speed of the vehicle along the route by means of at least one speed detection device of the sensor system. Preferably, the at least one triggering time can also be determined depending on the monitored current driving speed of the vehicle. The monitoring of the current driving speed can advantageously enable a particularly precise determination of the triggering time.

Preferably, the monitoring of the current driving speed can be performed automatically by means of a processing device.

In a further embodiment, the monitoring of the current vehicle position comprises an estimation, preferably extrapolation, of the current vehicle position from a current vehicle position last detected by means of a binary position sensor (e.g., one of the plurality of binary position sensors) of the sensor system and the monitored current driving speed. It is advantageous that the current vehicle position can be estimated very accurately by taking into account the current driving speed at positions between vehicle positions detected with high precision by binary position sensors.

In one embodiment, the signals from the at least one speed detection device are evaluated to detect a vehicle start of the vehicle and/or to detect a vehicle rear end of the vehicle and/or to detect at least one inter-vehicle transfer (transition) of the vehicle when monitoring the current driving speed.

In a further embodiment, the monitoring of the current driving speed comprises a sensor fusion of signals from a plurality of speed detection devices of the sensor system. This advantageously enables very precise monitoring of the current speed and thus very precise determination of the triggering time, even in difficult (e.g., weather) conditions.

In one embodiment, the at least one speed detection device comprises:
at least one lidar device; and/or
at least one radar device; and/or
at least one camera device.

In another embodiment, the at least one triggering time is determined when:
a distance between a position of the scanner device and the monitored current vehicle position is less than or equal to a predetermined distance limit value; and/or
a period of time until the vehicle reaches the scanner device is less than or equal to a predetermined time limit value, wherein preferably the period of time is determined from the monitored current vehicle position and optionally a monitored current driving speed of the vehicle along the route.

It is advantageous to determine the triggering time only when the vehicle is very close or sufficiently close to the scanner device. This is advantageous, for example, in preventing false scans due to sudden changes in driving speed or sudden vehicle stoppages. Instead, the triggering time can be determined very precisely in the near future, so that the desired inspection section is reliably in the scanner area of the scanner device when the scanner device is triggered at the triggering time.

In one embodiment, the inspection method further comprises providing a common time reference system (a common time base) for the sensor system and the triggering of the scanner device at the specific at least one triggering time by means of a (e.g., separate) time server. Advantageously, a very high precision of the inspection method can be achieved.

In a further embodiment, the at least one desired inspection section is a longitudinal side inspection section of the vehicle, a bottom side inspection section of the vehicle or a top side inspection section of the vehicle.

In one embodiment, the determination of the at least one triggering time is further dependent on a predetermined vehicle model in which the at least one desired inspection section is localized.

A further aspect of the present disclosure relates to an (e.g., fully or partially automated) inspection system for a vehicle, preferably a rail vehicle (e.g., a train, such as a self-propelled train). The inspection system has at least one, preferably camera-based, scanner device (e.g. roof scanner device(s), underfloor scanner device(s) and/or side scanner device(s)) that is arranged to scan, preferably record, at least one desired inspection section, preferably a longitudinal side section or underside section or top side section, of the vehicle. The inspection system further comprises a sensor system (e.g., comprising at least one binary position sensor and/or at least one speed detection device) for detecting the vehicle (e.g., along a route). The inspection system further comprises a processing device configured to execute an inspection method as disclosed herein. Optionally, the inspection system further comprises a (e.g., separate) time server configured to provide a common time reference system for the sensor system and/or the processing device. Optionally, the inspection system may comprise a (e.g., predetermined) route (e.g., rails or road) for the vehicle. The inspection system can advantageously be used to achieve the same advantages as those already explained with reference to the inspection method.

Preferably, a plurality of scanner devices can be included and the processing device can be configured to determine at least one triggering time for each of the plurality of scanner devices and to trigger the respective scanner device at the respectively determined triggering time(s).

Another aspect of the present disclosure relates to a computer program product comprising (e.g., at least one computer-readable storage medium having stored thereon) instructions that cause an inspection system, preferably as disclosed herein, to perform an inspection method as disclosed herein. Advantageously, the same advantages can be achieved with the computer program product as already explained with reference to the inspection method.

Preferably, the term “processing device” can refer to an electronic system (e.g., configured as a driver circuit or with microprocessor(s) and data memory) that, depending on its configuration, can perform control and/or regulation and/or processing tasks. Even though the term “controlling” is used herein, it may also be used to refer to “regulating” or “controlling with feedback” and/or “processing”.

For example, the processing device can be a central processing device. Alternatively, the processing device can comprise several processing units, e.g., a computing infrastructure such as a pre-processing computer and a programmable logic controller (PLC).

The preferred embodiments and features of the invention described above can be combined with each other in any way.

### BRIEF DESCRIPTION OF THE DRAWINGS

Further details and advantages of the invention will be described below with reference to the accompanying drawings. Showing:

FIG. 1 a schematic representation of an inspection system according to an embodiment of the present disclosure; and

FIG. 2 a schematic representation of an inspection method according to an embodiment of the present disclosure.

The embodiments shown in the figures correspond at least in part, so that similar or identical parts are provided with the same reference signs and, for their explanation, reference is also made to the description of the other embodiments or figures, in order to avoid repetition.

### DETAILED DESCRIPTION OF EXEMPLARY EMBODIMENTS

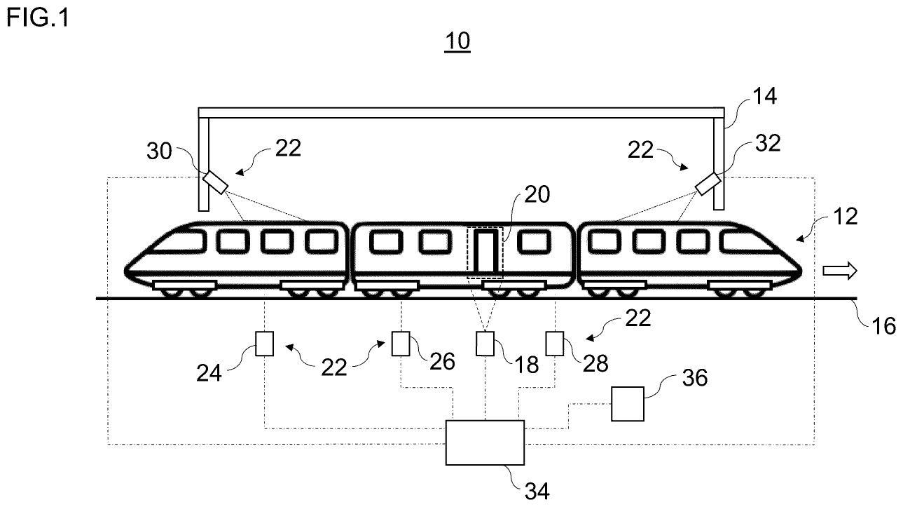

FIG. 1 shows an inspection system 10 for inspecting a vehicle 12, preferably while the vehicle 12 is moving.

The inspection system 10 can, for example, be arranged in an inspection hall 14. However, it is also possible that the inspection system 10 is arranged in the open air. It is possible that the vehicle 12 is longer than the inspection hall 14.

The vehicle 12 can transport people and/or goods. Preferably, the vehicle 12 is a land vehicle. In particular, the vehicle 12 is preferably a rail vehicle, as shown in FIG. 1. The rail vehicle can be, for example, a train, e.g., a self-propelled train. However, it is also possible that the vehicle 12 is configured differently. For example, the vehicle 12 can be a motor vehicle, e.g., a passenger car or a truck or a bus, an aircraft or a watercraft.

The vehicle 12 can move along a route 16 during the inspection. The route 16 can be, for example, a rail, a road or a waterway. The route 16 can run in the inspection hall 14 or through the inspection hall 14, provided that the inspection hall 14 is present.

The inspection system 10 comprises at least a scanner device 18, a sensor system 22 and a processing device 34. Optionally, the inspection system 10 can further comprise, for example, a time server 36.

The scanner device 18 can scan a desired inspection section 20 of the vehicle 12. To do this, the scanner device 18 can be triggered at a predetermined triggering time. The scanner device 18 can be configured accordingly as a trigger scanner device 18.

The scanner device 18 is preferably camera-assisted. For example, the scanner device 18 can comprise at least one camera. The at least one camera can take images (shots/recordings) of the desired inspection section 20. The at least one camera can preferably be a matrix camera. Alternatively, the scanner device 18 can, for example, comprise another, preferably optical, recording or detection system.

The desired inspection section 20 can, for example, be a longitudinal side inspection section of the vehicle 12, as shown in FIG. 1. Accordingly, the scanner device 18 can be arranged to scan a longitudinal side of the vehicle 12.

Alternatively, the desired inspection section 20 may be, for example, a bottom inspection section of the vehicle 12 or a top inspection section of the vehicle 12 (not shown in FIG. 1). Accordingly, the scanner device 18 may be arranged to scan a bottom or bottom side of the vehicle 12 or to scan an upper side or roof of the vehicle 12.

It is understood that more than one scanner device 18 may be included so that sections on different sides of the vehicle 12 can be scanned if desired. It is also understood that one and the same scanner device 18 can be triggered multiple times or at multiple specific triggering times on one and the same vehicle 12 in order to scan multiple inspection sections 20 of the vehicle 12.

The scanner device 18 can be a static or stationary scanner device. Alternatively, the scanner device 18 can be dynamic or movable. For example, the scanner device 18 can be movable parallel to the route 16 and/or transversely to the route 16 and/or vertically, e.g., during scanning and/or for setting a scanner position.

It is possible that the scanner device 18 is assigned an illumination system (not separately shown in FIG. 1). The illumination system can be switched on and off dependent on the particular triggering time, so that the illumination system illuminates the desired inspection section 20 at the time of scanning with the scanner device 18.

The sensor system 22 monitors a current vehicle position of the vehicle 12 along the route 16. Preferably, the sensor system 22 can track the current vehicle position of the vehicle 12 along the route 16.

The sensor system 22 can comprise several sensor devices 24-32. Preferably, the current vehicle position of the vehicle 12 along the route 16 can be determined by means of sensor fusion of signals from the several sensor devices 24-32 of the sensor system 22.

Preferably, the sensor system 22 comprises at least one binary position sensor 24, 26, 28. Preferably, a plurality of binary position sensors 24, 26, 28 are comprised, as described below.

The binary position sensors 24, 26, 28 can be arranged at a distance from one another along the route 16. Preferably, the binary position sensors 24, 26, 28 are arranged on both sides along the route 16 (not shown in FIG. 1). For example, the binary position sensors 24, 26, 28 can be arranged in pairs opposite each other on both long sides of the route 16.

The binary position sensors 24, 26, 28 can each detect a current vehicle position of the vehicle 12 when the vehicle 12 passes the respective binary position sensor 24, 26, 28. When passing, a light barrier path of the respective binary position sensor 24, 26, 28 can be blocked by the vehicle 12, e.g. by a wheel of the vehicle 12. A signal from the respective binary position sensor 24, 26, 28 can indicate that a predetermined part of the vehicle 12 has passed the respective binary position sensor 24, 26, 28. The binary position sensors 24, 26, 28 can preferably be arranged so that they can detect the passing of a wheel or an undercarriage or a bogie of the vehicle 12.

For example, the binary position sensors 24, 26, 28 can be configured as light barriers or similar.

Preferably, the binary position sensors 24, 26, 28 can carry out absolute measurements with respect to the vehicle position. For example, the position of the vehicle 12 relative to the at least one scanner device 18 can be determined indirectly by breaking the light barrier with the aid of master data of the vehicle 12 (known geometry).

The sensor system 22 may preferably comprise at least one speed detection device 30, 32. The at least one speed detection device 30, 32 can monitor a current driving speed of the vehicle 12 along the route 16.

The signals from the at least one speed detection device 30, 32 can be evaluated, for example, to detect the front of the vehicle 12 and/or to detect the rear of the vehicle 12 and/or to detect inter-vehicle transitions of the vehicle 12 in order to detect the driving speed of the vehicle 12.

The at least one speed detection device 30, 32 is preferably at least one lidar device. The lidar device can measure a speed of a vehicle side of the vehicle 12 (and thus a driving speed of the vehicle 12) relative to the orientation of the lidar device, e.g., perpendicular to the route 16 or to the vehicle side. The lidar device can, for example, be configured as a so-called laser surface velocimeter.

Alternatively or additionally, the at least one speed detection device 30, 32 can be, for example, at least one radar device. The radar device can measure a speed of a vehicle side of the vehicle 12 (and thus a driving speed of the vehicle 12) relative to the orientation of the radar device, e.g., at an angle of approximately 45° to the route 16 or to the vehicle side. For example, the radar device can be configured as a so-called continuous wave radar, CW radar, modulated continuous wave radar, frequency modulated continuous radar or FMCW radar.

Alternatively or additionally, the at least one speed detection device 30, 32 can be, for example, at least one camera device. Thus, for example, a camera can be used for speed measurements if the vehicle surface is suitable (e.g., structuring, profiling and/or texturing). In this case, the driving speed can be estimated, for example, by means of the image offset within small time intervals.

Preferably, several speed detection devices 30, 32 are included, e.g., two lidar devices, two radar devices and/or two camera devices. Monitoring the current driving speed can preferably be done by sensor fusion of signals from the multiple speed detection devices 30, 32.

The processing device 34 can be in communication with the scanner device 18 and the sensor system 22. The processing device 34 determines the triggering time for the scanner device 18. At the determined triggering time, the processing device 34 triggers the scanner device 18.

The processing device 34 can, for example, comprise a programmable logic controller (PLC) and a preprocessing computer.

The PLC can, for example, process signals from the binary position sensors 24, 26, 28 and/or the speed detection devices 30, 32 and forward them to the preprocessing computer. The PLC can, for example, monitor the reaching of the specific triggering time and trigger the scanner device 18 at the specific triggering time. For example, the PLC can wait for the triggering time and then send an analog signal for scanning, e.g., for image capturing, to the respective scanner device 18.

The pre-processing computer can receive the scanner images from the scanner device(s) 18 as well as (pre-processed) sensor data from the PLC. The pre-processing computer can optionally compress the scanner images and forward them for further processing, e.g., for an AI-supported evaluation of the scanner images.

The time server 36 can provide a common time reference system (a common time base) for the sensor system 22 and the processing device 34. For example, the signals from the sensor system 22 can be provided with a time stamp of the common time reference system, e.g., by means of the processing device 34, e.g., by means of the PLC of the processing device 34. For example, the processing device 34 can determine the triggering time in the common time reference system and perform the triggering at the determined triggering time with respect to the common time reference system.

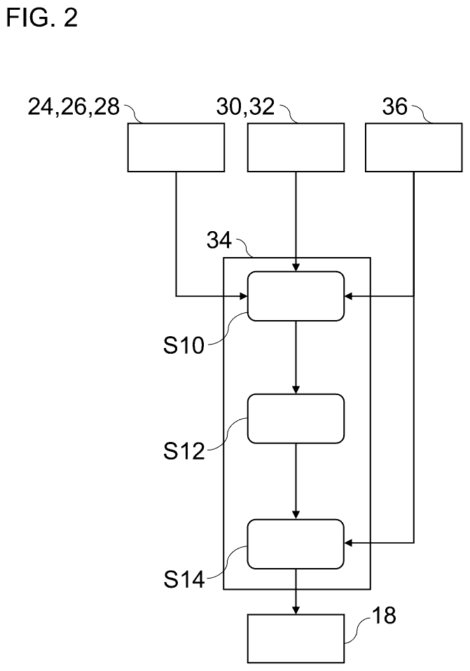

FIG. 2 shows an example of an inspection method in which the method steps S10-S14 are carried out by the processing device 34.

In a step S10, a current vehicle position of the vehicle 12 along the route 16 is monitored. For this purpose, signals from the binary position sensors 24, 26 and/or 28 can be processed.

In step S10, a current driving speed of the vehicle 12 along the route 16 is also monitored. For this purpose, signals from the speed detection devices 30 and/or 32 can be processed.

The current vehicle position of the vehicle 12 can be estimated (e.g., extrapolated) using the monitored current driving speed of the vehicle 12. In particular, the current vehicle position can be estimated from a current vehicle position last detected by means of a binary position sensor 24, 26 or 28 and the monitored current driving speed.

For example, position sensors 24, 26, 28 designed as light barriers can be used to detect the (absolute) vehicle position of the vehicle 12 at certain points along the route 16. Between these points, the position of the vehicle 12 can be estimated, e.g., extrapolated, with the help of the monitored driving speed. Thus, at positions where no absolute position measurement can be made by means of the binary position sensors 24, 26, 28 (e.g., between the wagon wheels), the current vehicle position can be extrapolated by integrating the driving speed.

The time server 36 can enable the processing of signals from the binary position sensors 24, 26, 28 and speed detection systems 30, 32 with a common time reference system.

In a step S12, the triggering time is determined as a function of the monitored current vehicle position of the vehicle 12 along the route 16 and, if applicable, as a function of the monitored current driving speed of the vehicle 12 along the route 16 (see explanations above). The triggering time may be in the future.

Furthermore, the triggering time can be determined depending on a predefined vehicle model with respect to the vehicle 12. The desired inspection section to be scanned by the scanner device 18 can be localized in the vehicle model. A reference point for which the current vehicle position is monitored can be localized in the vehicle model. In the vehicle model, the vehicle 12 can, for example, be modeled or represented geometrically, at least in part.

For example, the triggering time can be determined when a distance between a position of the scanner device 18 and the monitored current vehicle position is less than or equal to a predetermined distance limit. The distance limit can, for example, be specified by a user by means of a user interface.

Alternatively or additionally, the triggering time can be determined, for example, when a period of time until the vehicle 12 reaches the scanner device 18 is less than or equal to a predetermined time limit. The time limit can, for example, be specified by a user by means of a user interface. The time duration can be determined, for example, from the monitored current vehicle position and, optionally, the monitored current driving speed of the vehicle 12.

In a step S14, the scanner device 18 is triggered at the triggering time, preferably using the common time reference system from the time server 36. At the triggering time, the desired inspection section 20 is exactly within the scanning field/range of the scanner device 18. The scanner device 18, triggered at the triggering time, thus scans the desired inspection section 20 of the vehicle 12.

The invention is not limited to the preferred embodiments described above. Rather, a variety of variants and modifications are possible which also make use of the inventive concept and therefore fall within the scope of protection. In particular, the invention also claims protection for the subject matter and features of the dependent claims independently of the referenced claims. In particular, the individual features of the independent claim 1 are each independently disclosed.

### LIST OF REFERENCE SIGNS

10 Inspection system
12 vehicle
14 inspection hall
16 route
18 scanner device
20 inspection section
22 sensor system
24 binary position sensor
26 binary position sensor
28 binary position sensor
30 speed detection device
32 speed detection device
34 processing device
36 time server

What is claimed is:

1. An inspection method for inspecting a vehicle, the inspection method comprising:
monitoring a current vehicle position of the vehicle along a route for the vehicle via a sensor system;
determining at least one triggering time of a scanner device in dependence on the monitored current vehicle position; and
triggering the scanner device at the determined at least one triggering time for scanning at least one desired inspection section of the vehicle.

2. The inspection method according to claim 1, wherein at least one of:
the vehicle is a rail vehicle;
the monitoring includes tracking the current vehicle position of the vehicle along the route for the vehicle via the sensor system; and
the scanner device includes a camera.

3. The inspection method according to claim 1, wherein:
the sensor system comprises a plurality of sensor devices.

4. The inspection method according to claim 3, wherein:
the monitoring the current vehicle position comprises a sensor fusion of signals from the plurality of sensor devices of the sensor system.

5. The inspection method according to claim 1, wherein:
the sensor system comprises at least one binary position sensor;
a signal from the at least one binary position sensor indicates that a predetermined part of the vehicle is passing the respective binary position sensor; and
the predetermined part is a wheel or an undercarriage or a bogie of the vehicle.

6. The inspection method according to claim 1, wherein the monitoring the current vehicle position comprises:
detecting a current vehicle position along the route via a plurality of binary position sensors of the sensor system, the plurality of binary position sensors being arranged at a distance from one another along at least one of the route and on both sides along the route.

7. The inspection method according to claim 1, wherein at least one of:
the sensor system comprises at least one of a binary position sensor and a speed detection device;
the sensor system comprises at least one light barrier sensor; and
the monitoring the current vehicle position includes detecting a current vehicle position along the route via a plurality of light barriers of the sensor system.

8. The inspection method according to claim 1, further comprising:
monitoring of a current driving speed of the vehicle along the route via at least one speed detection device of the sensor system,
wherein the determining of the at least one triggering time is further carried out in dependence on the monitored current driving speed of the vehicle.

9. The inspection method according to claim 8, wherein the monitoring of the current vehicle position comprises:
estimating the current vehicle position from a current vehicle position last detected via a binary position sensor of the sensor system and from the monitored current driving speed.

10. The inspection method according to claim 9, wherein the estimating includes extrapolating.

11. The inspection method according to claim 8, wherein, when monitoring the current driving speed:
the signals of the at least one speed detection device are evaluated to detect at least one of a vehicle front end of the vehicle, a vehicle rear end of the vehicle, and at least one inter-vehicle transfer of the vehicle.

12. The inspection method according to claim 8, wherein:
the monitoring the current driving speed comprises a sensor fusion of signals of a plurality of speed detection devices of the sensor system.

13. The inspection method according to claim 8, wherein the at least one speed detection device comprises at least one of:
at least one lidar device;
at least one radar device; and
at least one camera device.

14. The inspection method according to claim 1, wherein at least one of:
the determining of the at least one triggering time occurs when a distance between a position of the scanner device and the monitored current vehicle position is smaller than or equal to a predetermined distance limit value; and
the at least one triggering time is determined when a period of time until the vehicle reaches the scanner device is less than or equal to a predetermined time limit.

15. The inspection method according to claim 14, wherein the period of time is determined from at least one of the monitored current vehicle position and a monitored current driving speed of the vehicle along the route.

16. The inspection method according to claim 1, further comprising:
providing a common time reference system for the sensor system and for triggering the scanner device at the determined at least one triggering time via a time server.

17. The inspection method according to claim 1, wherein at least one of:
the at least one desired inspection section is a longitudinal side inspection section of one of the vehicle, a bottom inspection section of the vehicle and a top inspection section of the vehicle; and
the determining the at least one triggering time is further carried out in dependence on a predetermined vehicle model in which the at least one desired inspection section is localized.

18. An inspection system for a vehicle, the inspection system comprising:
at least one scanner device that is arranged for scanning at least one desired inspection section of the vehicle;
a sensor system for detecting the vehicle; and
a processing device configured to execute an inspection method according to claim 1.

19. The inspection system according to claim 18, wherein at least one of:
the vehicle is a rail vehicle;
the at least one scanner device includes a camera;
the scanning includes recording;
the at least one desired inspection section of the vehicle includes one of a longitudinal side section, a bottom side section, and a top side section of the vehicle; and
the inspection system includes a time server configured to provide a common time reference system for at least one of the sensor system and the processing device.

20. A computer program product comprising instructions that cause an inspection system to carry out an inspection method according to claim 1.
